(19) United States
(12) Patent Application Publication
(10) Pub. No.: US 2025/0376009 A1
(43) Pub. Date: Dec. 11, 2025

(54) Air Filter System and Motor Vehicle

(71) Applicant: MAHLE International GmbH, Stuttgart (DE)

(72) Inventors: Sven Petzner, Welzheim (DE); Daniel Eberle, Ludwigsburg (DE)

(21) Appl. No.: 19/221,128

(22) Filed: May 28, 2025

(30) Foreign Application Priority Data
Jun. 5, 2024 (DE) 102024115686.4

(51) Int. Cl. B60H 3/00

(52) U.S. Cl. CPC B60H 3/0078

(57) ABSTRACT

An electrostatic air filter system, in particular for a motor vehicle is provided, which has a flow channel for an air flow, an ionizer for ionizing particles in the air flow that contains at least one discharge electrode and at least one counter electrode in the flow channel, a filter element for filtering particles out of the air flow that is downstream of the ionizer in the flow channel and contains a multilayer filter with at least one particle filter layer and at least one electrically conductive layer. The filtration capacity of the air filter system can be improved, in particular over time, in that the at least one conductive layer is connected to the at least one counter electrode by a resistor.

### CROSS-REFERENCE TO RELATED APPLICATIONS

This application claims priority from German Patent Application No. DE 102024115686.4, filed on Jun. 5, 2024, the entirety of which is hereby incorporated by reference herein.

The present invention relates to an electrostatic air filter system, preferably for a motor vehicle, according to the preamble of claim 1. The invention also relates to a motor vehicle equipped with such an air filter system.

For pleasant and healthy air quality, contaminants such as particulate matter, harmful gasses such as carbon dioxide and nitrous oxide, and unpleasant odors such as ammonia, trimethylamine, hydrogen sulfide, etc. must be removed the air in a vehicle interior or passenger compartment in a vehicle, and from the air that is supplied to the passenger compartment. A major problem with this, in particular in urban Asian areas, is the high amount of particulate matter polluting the air. This can often exceed the PM2.5 level, or the daily average of 15 μm/m³ stipulated by the WHO. Dust potentially entering the vehicle interior through fresh air systems is usually removed by a filter element in a filter system in the fresh air system, in which the filter element forms a particle filter or hybrid filter, or a combination filter containing a particle filter and an activated carbon filter, wherein the particle filter contains a fibrous layer that filters out these particles. This filter element is decisive for the air quality in the vehicle interior.

The fresh air system, which normally also contains an air conditioner, has very little space for the filter element. The air conditioner and filter system are also often combined in a housing. For this reason, the filter element must exhibit low flow resistance and/or pressure losses, such that the air flow can enter the vehicle interior, thus satisfying safety requirements, e.g. preventing condensation on the windows. This has the disadvantage that a particle filtering layer is usually open-pored, resulting in poor filtration by the filter element. Many filter and/or filter fiber layer manufacturers therefore charge the filter electrostatically in the production process. This results in a better filtering of charged particles. This also effectively filters out very small particles of less than 0.3 μm, without increasing flow resistance and/or pressure losses caused by the filter element. Unfortunately, this electrostatic charge diminishes over time, and becomes less effective as the filter element becomes clogged. The electrostatic charging of the filter element is therefore only really effective at the start of its service life. This decrease in the electrostatic charge can start to take place within a few weeks or months, depending on the level of air pollution.

Particles can be electrostatically charged with ionizers. These are placed upstream of the filter element in the air flow, and charge the particles found therein. The ions introduced into the air also charge the filter element to a certain extent. This improves the overall filtering effect, complimenting the purely mechanical filtration by the filter element, by maintaining the electrostatic filtering effect over a longer period of time.

The ionizers usually contain a negative discharge electrode that generates a corona discharge. Electrons accumulate on a discharge electrode with a negative corona discharge, which normally contains a row of points, e.g. in the form of thorns or needles, which are highly accelerated near the discharge electrode. These electrons collide with gas molecules, which then lose another electron and thus become positively charged. This results in a positive gas molecule or ion, and two electrons. This effect mainly occurs with very high field strengths at a short distance to the discharge electrode. At greater distances, the electrons attach to gas molecules, thus forming negative gas ions. More gas ions are formed with a negative corona discharge than with a positive corona discharge, because the smaller electrons travel faster. This facilitates the charging of the particles, and therefore the removal thereof in the downstream filter element.

The gas flow therefore contains positive and negative ions, which then attach themselves to the particles. The net charge with a negative corona discharge always remains negative, because it introduces electrons into the air flow.

The electrostatic charging of the filter element diminishes over time, because the dust that accumulates on the filter element also interferes with the electrostatic charge.

An electrostatic air filter system of this type is disclosed in U.S. Pat. No. 5,403,383 A. It functions with a flow channel for an air flow, and contains an ionizer with which the particles in the air flow are ionized that contains a discharge electrode and a counter electrode in the flow channel. There is also a particle filter element for filtering out the particles in the air flow downstream of the ionizer in the flow channel that contains a multilayered filter with a particle filter layer and an electrically conductive layer. The counter electrode and electrically conductive layer in this air filter system are both grounded.

The present invention is concerned with the problem of creating a better design for an ionizer of the type described above, an air filter system equipped therewith, and a vehicle equipped therewith, distinguished in particular by an extremely effective particle filtration over a longer service life.

This problem is solved with the invention by the subject matter of the independent claims. Advantageous embodiments are the subject matter of the dependent claims.

The invention is based on the general idea of connecting the conductive layer in the filter element to the counter electrodes with a resistor. This results in the conductive layer being connected to the same potential as the counter electrodes. Consequently, the electrostatic charging of the particle filter element is constantly regenerated. This significantly reduces the current flowing toward the particle filter element. A higher current results in excessive flow through the filter element, which in turn results in a less effective charging of the particles. The resistor ensures an optimal balance between ionization and regeneration of the filter element, thus resulting in an optimal filtration supplemented by the ionizer. This also reduces the formation of ozone in the air filter system. This also makes better use of the electricity available for ionization, and furthermore improves the filtration obtained with the air filter system.

In detail, an electrostatic air filter system is proposed, which contains a flow channel for an air flow, an ionizer that ionizes particles in the air flow, and a filter element that filters out particles in the air flow. The ionizer has at least one discharge electrode and one counter electrode in the flow channel. The filter element is downstream of the ionizer in the flow channel, and contains a multilayered filter that has at least one particle filter layer and at least one electrically conductive layer. Essential to the invention is that the at least one conductive layer is connected to the at least one counter electrode by a resistor, preferably an ohmic resistor.

Because the filter element is downstream of the ionizer in the flow channel, all of the electrodes in the ionizer are upstream of the filter element.

The filter element can at least form a particle filter, and therefore contains at least one particle filter layer. This filter element is preferably a hybrid filter or combination filter, which contains at least one particle filter layer and at least one activated carbon layer.

The resistor can be formed by one or more resistor elements, which can be connected in series or parallel.

The particle filter layer can be electrically insulating and dielectrically configured.

In an advantageous embodiment, the resistor can be a high-resistance resistor. With a high-resistance resistor, the current flowing to the conductive layer in the filter element is significantly reduced, resulting in more electricity being available for ionizing the particles, thus improving the filtering effect of the air filter system.

A resistor is regarded as high-resistance if the resistance is at least 500 times the voltage in the system, or network. In the present case, the resistance can therefore be at least 500 times the voltage in the ionizer. With a voltage of 10 kV, the resistor therefore has a resistance of at least 5 MOhm.

In an advantageous embodiment, the resistor can be placed in an electrical connection that connects the at least one conductive layer directly to the at least one counter electrode. In other words, it is proposed herein that the conductive layer be connected to the counter electrode starting from a contact on the filter element, by the electrical connection and through the high-resistance resistor. The electrical connection can be formed by a connecting wire or cable, or a printed circuit board, etc.

The resistance can range from 10 MOhm to 100 MOhm in an advantageous embodiment.

This resistance can be at least 10 MOhm, at least 15 MOhm, at least 20 MOhm, or at least 25 MOhm.

The resistance can also be no more than 100 MOhm, no more than 90 MOhm, no more than 40 MOhm, or no more than 35 MOhm.

A particularly advantageous embodiment has proven to have a resistance of approx. 30 MOhm, i.e. 30 MOhm±10%, i.e. ranging from 27 MOhm to 33 MOhm.

The resistance in another advantageous embodiment is at least 500 times the voltage applied to the at least one discharge electrode when the ionizer is in operation. With a voltage of 10 KV, this resistance is therefore at least 5 MOhm.

This ionizer can ideally be configured to generate a corona discharge at the discharge electrode and/or apply a voltage to the discharge electrode of at least 5 kV, 6 kV, 10 KV, or 15 kV.

The term “configuration” in this context means the same as “design” and/or “set-up” and/or “programming,” such that the formulation, “configured such” means the same as the formulation “designed such,” and/or “set-up such” and/or “programmed such.”

The ionizer can have a high voltage generator to which the respective discharge electrode and counter electrode are connected. Ideally, each discharge electrode and each counter electrode is connected to the high voltage generator.

The vehicle obtained with the invention has an interior and an air conditioner for the air supplied to the interior. The air conditioner contains an air filter system of the type described above.

Other important features and advantages of the invention can be derived from the dependent claims, drawings, and associated descriptions of the drawings.

It is clear that the features specified above and explained below can be used not only in the given combinations, but also in other combinations and in and of themselves, without abandoning the scope of the invention defined by the claims. Components in a superordinate unit specified herein, e.g. a system, device, or assembly, which are indicated separately, can form separate components of this unit, or be integral parts thereof, even if the drawings indicate otherwise.

Preferred exemplary embodiments of the invention are shown in the drawing and shall be explained below in greater detail, in which the same reference symbols are used for identical, similar, or functionally identical components.

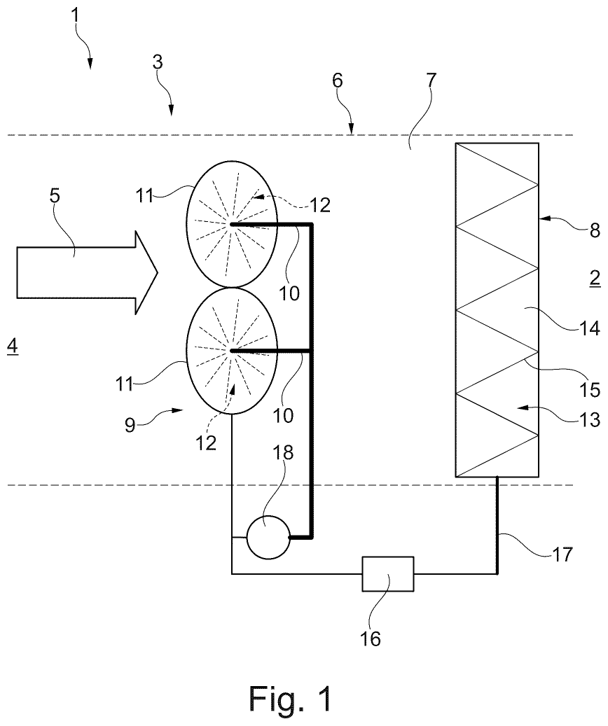

The sole FIG. 1 shows a highly simplified drawing of a motor vehicle, resembling a circuit diagram, illustrating an air filter system.

FIG. 1 only shows part of a motor vehicle 1, which contains the vehicle interior 2 and an air conditioner 3 that is designed to supply fresh air from the environment 4 in which the vehicle 1 is located, and/or from the vehicle interior 2 to the vehicle interior 2. This forms an air flow 5 indicated by an arrow. The air conditioner 3 contains an electrostatic air filter system 6, which has a flow channel 7 indicated by broken lines. The air filter system 6 is incorporated in the air conditioner 3 such that the air flow 5 also passes through the flow channel 7.

The electrostatic air filter system 6 comprises the flow channel 7 for the air flow 5, and a filter element 8 that is placed in the flow channel 7 such that the air flow 5 passes through the filter element 8. The air filter system 6 also has an ionizer 9 with which particles in the air flow 5 can be ionized in order to improve accumulation of these particles in the filter element 8. The filter element 8 can be electrostatically charged in order to facilitate accumulation of the ionized particles.

The air conditioner 3 is used on the air flow 5 and can contain a cooler and/or heater, not shown herein, with which the air flow 5 can be cooled or heated, and potentially dehumidified, as needed. The air conditioner 3 is ideally configured to act on the air flow 5 downstream of the filter system 6. Ideally, the air filter system 6 is contained in a housing, not shown herein.

The ionizer 9 contains at least one discharge electrode 10 and at least one counter electrode 11 upstream of the filter element 8. FIG. 1 shows two discharge electrodes 10, purely by way of example, which interact with two counter electrodes 11. These discharge electrodes 10 and counter electrodes 11 are upstream of the filter element 8 in the flow channel 7. If there are multiple discharge electrodes 10 and multiple counter electrodes 11, all of the discharge electrodes 10 and counter electrodes 11 are upstream of the filter element 8 in the flow channel 7.

The discharge electrodes 10 and counter electrodes 11 are placed in the flow channel 7 such that the air flow 5 can flow around them. When the ionizer 9 is in operation, the discharge electrodes 10 and counter electrodes 11 generate an electrical field 12 between them, indicated by a broken line in the drawing. This ionizes particles flowing through the field 12 in the air flow 5.

The filter element contains a multilayered filter 13, which contains at least one particle filter layer 14 and at least one conductive layer 15. The layers 14, 15 can be pleated to increase the surface area available for filtration. The conductive layer 15 can be formed by conductive fibers or wires, and placed on top of the particle filter layer. This conductive layer 15 could also be made of activated carbon and placed downstream of the particle filter layer 14. In this case, the filter element 8 is a hybrid filter. With a hybrid or combination filter, the conductive layer 15 is provided in addition to the particle filter layer 14 and the activated carbon layer.

The conductive layer 15 in the drawing is connected to the counter electrodes 11 by a resistor 16. The resistor 16 is preferably a high-resistance resistor 16. In this example, the resistor is in an electrical connection 17 that connects the conductive layer 15 directly to the counter electrode 11. This conductive layer 15 is not grounded directly. The electrical connection 17 is preferably connected to a contact formed on the filter element 8, which is connected within the filter element 8 to the conductive layer 15.

The resistor 16 can have a resistance of at least 10 MOhm, 15 MOhm, 20 MOhm, 25 MOhm. It can also have a maximum resistance of 50 MOhm, 45 MOhm, 40 MOhm, or 35 MOhm. The resistance can therefore lie in a range of 10 MOhm to 100 MOhm, 15 MOhm to 45 MOhm, 20 MOhm to 40 MOhm, or 25 MOhm to 35 MOhm, whereas the narrower ranges are preferred over the broader ranges. It has proven to be particularly advantageous when the resistance lies within a range of 27 MOhm to 33 MOhm, i.e. 30 MOhm±10%, and is ideally 30 MOhm.

The ionizer 9 functions with high voltage applied to the discharge electrodes 10. The ionizer 9 can have a high voltage generator 18 for this, which is connected to the discharge electrodes 10 and counter electrodes 11. The ionizer 9 be configured for a voltage of at least 5 kV, 6 kV, 10 KV, 12 kV, 13 KV, or 15 kV. In particular, the ionizer 9 can be configured to generate a corona discharge at the discharge electrodes 10. This corona discharge results in the field 12, which can also be referred to as a corona field 12, discharge field 12, or corona discharge field 12.

The resistor 15 in a preferred design can have a resistance of at least 500 times the voltage that is applied to the discharge electrodes 10 when the ionizer is in operation. With a voltage of 15 kV, the resistance is therefore at least 10 MOhm.

The specification can be readily understood with reference to the following Numbered Paragraphs:

Numbered Paragraph 1. An electrostatic air filter system (6), in particular for a motor vehicle (1), which has
a flow channel (7) for an air flow (5),
an ionizer (9) for ionizing particles in the air flow (5) that contains at least one discharge electrode (10) and at least one counter electrode (11) in the flow channel (7),
a filter element (8) for filtering particles out of the air flow (5) that is downstream of the ionizer (9) in the flow channel (7), and contains a multilayer filter (13) with at least one particle filter layer (14) and at least one electrically conductive layer (15),

characterized in that the at least one conductive layer (15) is connected to the at least one counter electrode (11) by a resistor (16).

Numbered Paragraph 2. The air filter system (6) according to Numbered Paragraph 1, characterized in that the resistor (16) is a high-resistance resistor (16).

Numbered Paragraph 3. The air filter system (6) according to either of the preceding Numbered Paragraphs, characterized in that the resistor (16) is incorporated in an electrical connection (17) that connects the at least one conductive layer (15) directly to the at least one counter electrode (11).

Numbered Paragraph 4. The air filter system (6) according to any of the preceding Numbered Paragraphs, characterized in that
the resistor (16) has a resistance of 10 MOhm to 50 MOhm, or
the resistor (16) has a resistance of 15 MOhm to 45 MOhm, or
the resistor (16) has a resistance of 20 MOhm to 40 MOhm, or
the resistor (16) has a resistance of 25 MOhm to 35 MOhm.

Numbered Paragraph 5. The air filter system (6) according to any of the preceding Numbered Paragraphs, characterized in that
the resistor (16) has a resistance of at least 10 MOhm, or
the resistor (16) has a resistance of at least 15 MOhm, or
the resistor (16) has a resistance of at least 20 MOhm, or
the resistor (16) has a resistance of at least 25 MOhm.

Numbered Paragraph 6. The air filter system (6) according to any of the preceding Numbered Paragraphs, characterized in that
the resistor (16) has a resistance of no more than 100 MOhm, or
the resistor (16) has a resistance of no more than 90 MOhm, or
the resistor (16) has a resistance of no more than 80 MOhm, or
the resistor (16) has a resistance of no more than 70 MOhm.

Numbered Paragraph 7. The air filter system (6) according to any of the preceding Numbered Paragraphs, characterized in that the resistor (16) has a resistance of 30 MOhm.

Numbered Paragraph 8. The air filter system (6) according to any of the preceding Numbered Paragraphs, characterized in that the resistor (16) has a resistance that is at least 500 times a voltage applied to the at least one discharge electrode (10) when the ionizer (9) is in operation.

Numbered Paragraph 9. The air filter system (6) according to any of the preceding Numbered Paragraphs, characterized in that the ionizer (9) is configured to generate a corona discharge at the discharge electrode (10), and/or apply a voltage to the discharge electrode (10) of at least 5 kV.

Numbered Paragraph 10. A motor vehicle (1), that has
a vehicle interior (2),
an air conditioner (3) for the air flow (5) supplied to the interior (2),

wherein the air conditioner (3) has an air filter system (6) according to any of the preceding Numbered Paragraphs.

### List of Reference Symbols

1 motor vehicle
2 vehicle interior
3 air conditioner
4 environment
5 air flow
6 air filter system
7 flow channel
8 filter element
9 ionizer
10 discharge electrode
11 counter electrode
12 field
13 filter
14 particle filter layer
15 electrically conductive layer
16 resistor
17 electrical connection
18 high voltage generator

1-10. (canceled)

11. An electrostatic air filter system, in particular for a motor vehicle, comprising:
a flow channel for an air flow,
an ionizer for ionizing particles in the air flow that comprises at least one discharge electrode and at least one counter electrode in the flow channel,
a filter element for filtering particles out of the air flow that is downstream of the ionizer in the flow channel, and comprises a multilayer filter with at least one particle filter layer and at least one electrically conductive layer,
wherein the at least one conductive layer is connected to the at least one counter electrode by a resistor.

12. The air filter system of claim 11, wherein the resistor is a high-resistance resistor.

13. The air filter system of claim 11, wherein the resistor is incorporated in an electrical connection that connects the at least one conductive layer directly to the at least one counter electrode.

14. The air filter system of claim 11, wherein
the resistor has a resistance of 10 MOhm to 50 MOhm, or
the resistor has a resistance of 15 MOhm to 45 MOhm, or
the resistor has a resistance of 20 MOhm to 40 MOhm, or
the resistor has a resistance of 25 MOhm to 35 MOhm.

15. The air filter system of claim 11, wherein
the resistor has a resistance of at least 10 MOhm, or
the resistor has a resistance of at least 15 MOhm, or
the resistor has a resistance of at least 20 MOhm, or
the resistor has a resistance of at least 25 MOhm.

16. The air filter system of claim 11, wherein
the resistor has a resistance of no more than 100 MOhm, or
the resistor has a resistance of no more than 90 MOhm, or
the resistor has a resistance of no more than 80 MOhm, or
the resistor has a resistance of no more than 70 MOhm.

17. The air filter system of claim 11, wherein that the resistor has a resistance of 30 MOhm.

18. The air filter system of claim 11, wherein the resistor has a resistance that is at least 500 times a voltage applied to the at least one discharge electrode when the ionizer is in operation.

19. The air filter system of claim 11, wherein that the ionizer is configured to generate a corona discharge at the discharge electrode, and/or apply a voltage to the discharge electrode of at least 5 kV.

20. A motor vehicle, comprising
a vehicle interior,
an air conditioner for the air flow supplied to the interior,
wherein the air conditioner has an air filter system according to claim 11.
